(19) United States
(12) Patent Application Publication
(10) Pub. No.: US 2020/0014041 A1
(43) Pub. Date: Jan. 9, 2020

(54) FUEL CELL SEPARATOR MEMBER AND FUEL CELL STACK

(71) Applicant: HONDA MOTOR CO., LTD., Tokyo (JP)

(72) Inventors: Shuhei Goto, Wako-shi (JP); Yu Tomana, Wako-shi (JP); Akihito Giga, Wako-shi (JP)

(21) Appl. No.: 16/502,068

(22) Filed: Jul. 3, 2019

(30) Foreign Application Priority Data
Jul. 6, 2018 (JP) 2018-128661

(51) Int. Cl. H01M 8/0276; H01M 8/0258; H01M 8/0267; H01M 8/2475; H01M 8/0273

(52) U.S. Cl. CPC H01M 8/0276; H01M 8/0258; H01M 2250/20; H01M 8/2475; H01M 8/0273; H01M 8/0267

(57) ABSTRACT

In a coolant inlet bridge section of a fuel cell separator member constituting a component of a fuel cell stack, as viewed in plan from a separator thickness direction, a first projection forming a first communication passage that communicates with a coolant supply passage extends in a manner so as to intersect with a second communication passage bead section, and a second projection forming a second communication passage configured to enable mutual communication between the first communication passage and a coolant flow field extends in a manner so as to intersect with a first communication passage bead section.

### CROSS-REFERENCE TO RELATED APPLICATION

This application is based upon and claims the benefit of priority from Japanese Patent Application No. 2018-128661 filed on Jul. 6, 2018, the contents of which are incorporated herein by reference.

### BACKGROUND OF THE INVENTION

### Field of the Invention

The present invention relates to a fuel cell separator member and a fuel cell stack, in which a coolant flow field is formed between a first separator and a second separator that are stacked on each other.

### Description of the Related Art

For example, a solid polymer electrolyte fuel cell is equipped with a membrane electrode assembly (MEA) in which an anode is disposed on one side surface and a cathode is disposed on another side surface, respectively, of an electrolyte membrane made up from a polymer ion exchange membrane. In the fuel cell, the membrane electrode assembly is sandwiched between separators (bipolar plates) in order to form a power generation cell (unit cell). A fuel cell stack comprising a stacked body in which a predetermined number of power generation cells are stacked together, for example, is mounted in a fuel cell vehicle (a fuel cell electric vehicle or the like).

In such a fuel cell stack, there are situations in which metallic separators that serve as separators are used therewith. At that time, in order to prevent leakage of a reactant gas (an oxygen-containing gas, a fuel gas) and a coolant, seal members are provided on the separators.

For such seal members, elastic rubber seals made of fluorine-based rubber or silicone or the like are used, which leads to a rise in costs. Thus, for example, as disclosed in the specification of U.S. Pat. No. 7,718,293, instead of such elastic rubber seals, a structure has been adopted in which convexly shaped bead seals are formed in the separators.

### SUMMARY OF THE INVENTION

Two separators that lie adjacent to one another in the fuel cell stack are joined together mutually in a manner so as to form a coolant flow field between the separators and thereby constitute the separator member. A coolant passage is formed in the separator member in the separator thickness direction. The coolant passage is surrounded by a convexly shaped bead seal.

Bridge sections for allowing the coolant passage and the coolant flow field to communicate with each other are provided in the separators. The bridge sections may include an inner side tunnel connected to an inner peripheral wall of a bead seal and communicating with the coolant passage, and an outer side tunnel connected to an outer peripheral wall of the bead seal and communicating with the coolant flow field.

In this case, a connecting portion that connects with the inner side tunnel is cut out from within the inner peripheral wall portion of the bead seal, and a connecting portion that connects with the outer side tunnel is cut out from within the outer peripheral wall portion of the bead seal. Therefore, the load bearing characteristics of the connecting portions of the bead seal are lower than that of other portions (portions apart from the connecting portions) of the bead seal. Concerning the surface pressure applied to the bead seal (the contact pressure at a tip end of the bead seal), it would be desirable to suppress variations therein.

The present invention has been devised taking into consideration the aforementioned problems, and has the object of providing a separator member and a fuel cell stack in which, with a simple and economical configuration, it is possible to make the surface pressure applied to the bead seals that surround a coolant passage uniform.

One aspect of the present invention is characterized by a fuel cell separator member comprising a first separator and a second separator which are made of metal and stacked on each other, and in which there are formed a coolant flow field provided between the first separator and the second separator, a coolant passage that penetrates in a separator thickness direction, and a bridge section configured to enable mutual communication between the coolant flow field and the coolant passage, wherein a first bead seal configured to prevent fluid leakage and which projects in an opposite direction to the second separator from a surface of the first separator in a surrounding manner to the coolant passage, is formed in the first separator, a second bead seal configured to prevent fluid leakage and which projects in an opposite direction to the first separator from a surface of the second separator in a surrounding manner to the coolant passage, is formed in the second separator, and the fuel cell separator member is stacked on a membrane electrode assembly and a compressive load is applied thereto in a stacking direction, wherein the bridge section includes a first projection formed in a spaced apart manner with respect to the first bead seal, and which projects in an opposite direction to the second separator from the surface of the first separator, and forms a first communication passage communicating with the coolant passage, and a second projection formed in a spaced apart manner with respect to the second bead seal, and which projects in an opposite direction to the first separator from the surface of the second separator, and forms a second communication passage configured to enable mutual communication between the first communication passage and the coolant flow field, and wherein, as viewed in plan from the separator thickness direction, the first projection extends in a manner so as to intersect with the second bead seal, and the second projection extends in a manner so as to intersect with the first bead seal.

Another aspect of the present invention is characterized by a fuel cell stack includes separator members and a membrane electrode assembly alternately stacked on each other, the separator members each comprising a first separator and a second separator which are made of metal and stacked on each other, wherein in each of the fuel cell separator members, there are formed a coolant flow field provided between the first separator and the second separator, a coolant passage that penetrates in a separator thickness direction, and a bridge section configured to enable mutual communication between the coolant flow field and the coolant passage, wherein a first bead seal configured to prevent fluid leakage and which projects in an opposite direction to the second separator from a surface of the first separator in a surrounding manner to the coolant passage, is formed in the first separator, a second bead seal configured to prevent fluid leakage and which projects in an opposite direction to the first separator from a surface of the second separator in a surrounding manner to the coolant passage, is formed in the second separator, and the fuel cell separator members are stacked on the membrane electrode assembly and a compressive load is applied thereto in a stacking direction, wherein the bridge section includes a first projection formed in a spaced apart manner with respect to the first bead seal, and which projects in an opposite direction to the second separator from the surface of the first separator, and forms a first communication passage communicating with the coolant passage, and a second projection formed in a spaced apart manner with respect to the second bead seal, and which projects in an opposite direction to the first separator from the surface of the second separator, and forms a second communication passage configured to enable mutual communication between the first communication passage and the coolant flow field, and wherein, as viewed in plan from the separator thickness direction, the first projection extends in a manner so as to intersect with the second bead seal, and the second projection extends in a manner so as to intersect with the first bead seal.

According to the present invention, because the first projection is not connected to the first bead seal, a notched portion is not formed in the first bead seal. Further, because the second projection is not connected to the second bead seal, a notched portion is not formed in the second bead seal. Therefore, the load bearing characteristics of the first bead seal and the second bead seal do not undergo deterioration. Thus, with a simple and economical configuration, the surface pressure applied to the bead seals (the first bead seal and the second bead seal) that surround the coolant passage can be made uniform.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a perspective view of a fuel cell stack according to an embodiment of the present invention;

FIG. 2 is a longitudinal cross-sectional view with partial omission of the fuel cell stack;

FIG. 3 is an exploded perspective view showing a power generation cell that makes up a portion of the fuel cell stack;

FIG. 4 is a front view of a fuel cell separator member as viewed from the side of a first separator;

FIG. 5 is a front view of a fuel cell separator member as viewed from the side of a second separator;

FIG. 6 is an explanatory view of essential components of a first bead seal surrounding a coolant supply passage in the first separator as viewed from the side of the first separator;

FIG. 7 is an explanatory view of essential components of a second bead seal surrounding a coolant supply passage in the second separator as viewed from the side of the first separator;

FIG. 8A is a perspective view with partial omission of the first separator;

FIG. 8B is a perspective view with partial omission of the second separator;

FIG. 9 is a cross-sectional view taken along line IX-IX of FIG. 6; and

FIG. 10 is a cross-sectional view taken along line X-X of FIG. 6.

### DESCRIPTION OF THE PREFERRED EMBODIMENTS

Preferred embodiments of a fuel cell separator member and a fuel cell stack according to the present invention will be presented and described below with reference to the accompanying drawings.

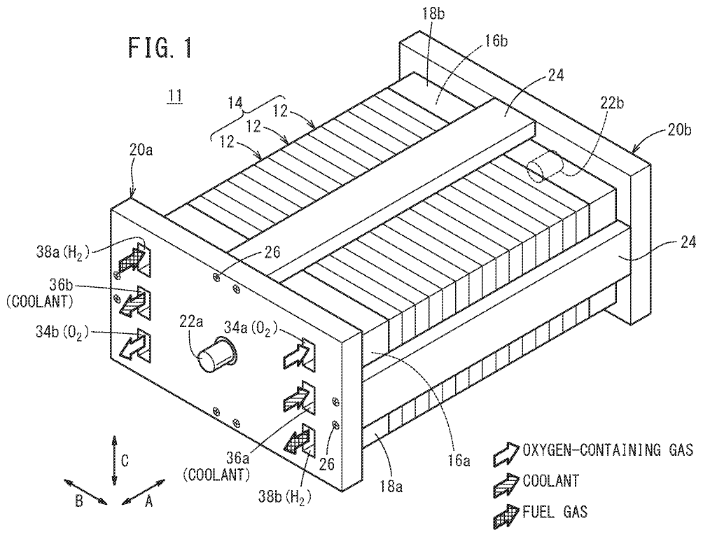

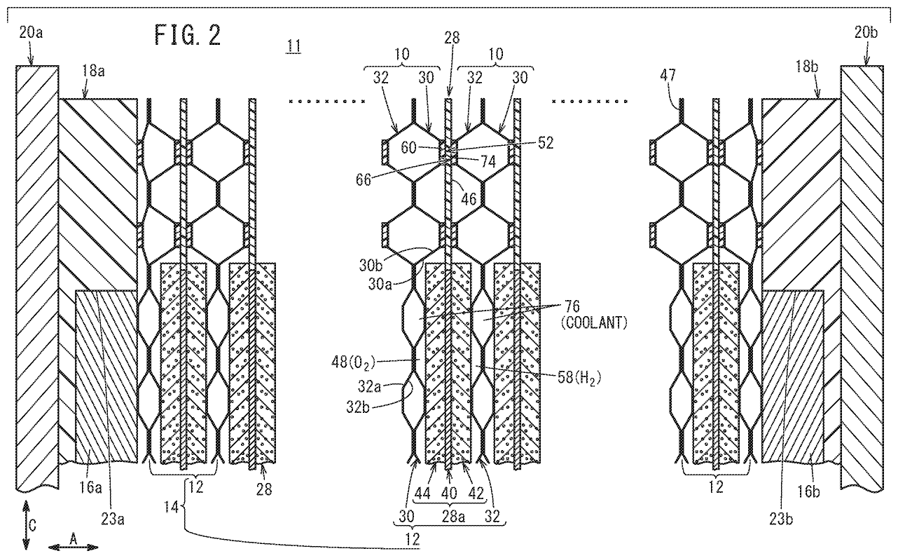

As shown in FIGS. 1 and 2, a fuel cell stack 11 according to a first embodiment of the present invention comprises a stacked body 14 in which a plurality of power generation cells 12 are stacked in a horizontal direction (the direction of the arrow A). The fuel cell stack 11, for example, is mounted in a fuel cell vehicle such as a fuel cell electric automobile (not shown).

A terminal plate 16a, an insulator 18a, and an end plate 20a are arranged in this order sequentially toward the outside on one end in the stacking direction (the direction of the arrow A) of the stacked body 14. A terminal plate 16b, an insulator 18b, and an end plate 20b are arranged in this order sequentially toward the outside on another end in the stacking direction of the stacked body 14.

As shown in FIG. 2, the terminal plates 16a and 16b are made from a material possessing electrical conductivity, for example, a metal such as copper, aluminum, or stainless steel, etc. A terminal 22a that extends outwardly in the stacking direction is provided substantially in the center of the terminal plate 16a, and a terminal 22b that extends outwardly in the stacking direction is provided substantially in the center of the terminal plate 16b (see FIG. 1).

The insulators 18a and 18b are formed by an insulating material, for example, polycarbonate (PC) or phenol resin or the like. In a central portion of the insulator 18a, a recess 23a is formed which opens toward the stacked body 14 together with the terminal plate 16a being accommodated therein. In a central portion of the insulator 18b, a recess 23b is formed which opens toward the stacked body 14 together with the terminal plate 16b being accommodated therein.

As shown in FIG. 1, the end plates 20a and 20b have horizontally elongate shapes (they may also have vertically elongate shapes), together with coupling bars 24 being arranged between respective sides of the end plates 20a and 20b. Both ends of the respective coupling bars 24 are fixed via bolts 26 to inner surfaces of the end plates 20a and 20b, so as to apply a tightening load (compressive load) to the plurality of stacked power generation cells 12 in the stacking direction (in the direction of the arrow A). The fuel cell stack 11 may be equipped with a casing in which the end plates 20a and 20b are provided as end plates thereof, and a structure may be provided in which the stacked body 14 is accommodated inside such a casing.

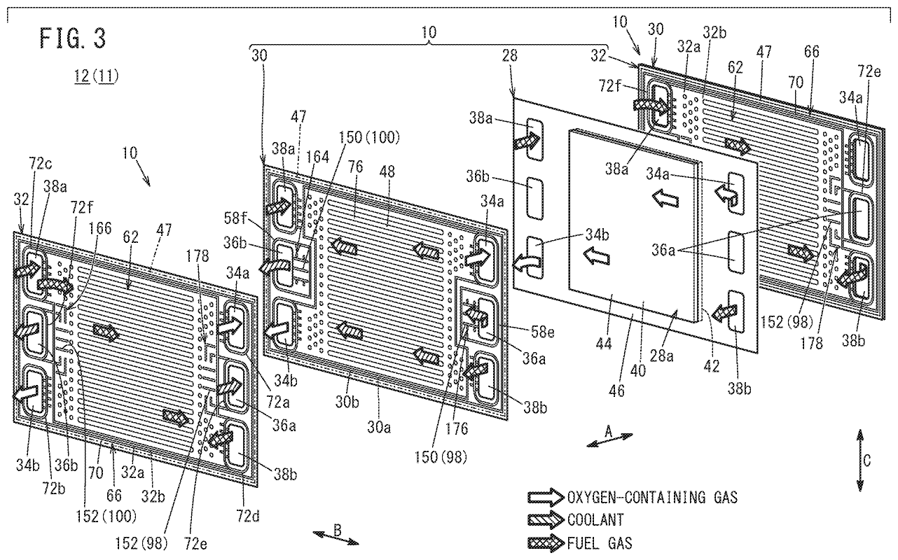

As shown in FIG. 2, in each of the power generation cells 12, a membrane electrode assembly 28 (hereinafter, abbreviated as MEA 28) is sandwiched by a first separator 30 and a second separator 32. As shown in FIG. 3, at one end of the power generation cell 12 in the direction of the arrow B (in the horizontal direction in FIG. 2), an oxygen-containing gas supply passage 34a, a coolant supply passage (coolant passage) 36a, and a fuel gas discharge passage 38b are provided.

The oxygen-containing gas supply passage 34a, the coolant supply passage 36a, and the fuel gas discharge passage 38b are arranged sequentially in a vertical direction as indicated by the arrow C. An oxygen-containing gas is supplied through the oxygen-containing gas supply passage 34a. A coolant is supplied through the coolant supply passage 36a. A fuel gas, for example, a hydrogen-containing gas, is discharged through the fuel gas discharge passage 38b.

At the other end of the power generation cell 12 in the direction of the arrow B, a fuel gas supply passage 38a, a coolant discharge passage (coolant passage) 36b, and an oxygen-containing gas discharge passage 34b are provided, which communicate mutually in the direction of the arrow A and are arranged sequentially in the direction of the arrow C.

The fuel gas is supplied through the fuel gas supply passage 38a. The coolant is discharged through the coolant discharge passage 36b. The oxygen-containing gas is discharged through the oxygen-containing gas discharge passage 34b. The arrangement of the oxygen-containing gas supply passage 34a and the oxygen-containing gas discharge passage 34b as well as the fuel gas supply passage 38a and the fuel gas discharge passage 38b is not limited to that shown for the present embodiment. Depending on the required specifications therefor, the arrangement may be set appropriately.

As shown in FIG. 2, the MEA 28 is equipped with an MEA main body 28a and a resin film 46 provided on an outer peripheral portion of the MEA main body 28a. The MEA main body 28a includes an electrolyte membrane 40, and an anode 42 and a cathode 44 sandwiching the electrolyte membrane 40 therebetween.

The electrolyte membrane 40, for example, is a solid polymer electrolyte membrane (cation ion exchange membrane). The solid polymer electrolyte membrane is formed by impregnating a thin membrane of perfluorosulfonic acid with water, for example. The electrolyte membrane 40 is sandwiched and gripped between the anode 42 and the cathode 44. A fluorine based electrolyte may be used as the electrolyte membrane 40. Alternatively, an HC (hydrocarbon) based electrolyte may be used as the electrolyte membrane 40. The electrolyte membrane 40 has a smaller planar dimension (external dimension) than the anode 42 and the cathode 44.

The resin film 46 in the shape of a frame is sandwiched between an outer peripheral edge portion of the anode 42 and an outer peripheral edge portion of the cathode 44. An inner peripheral edge surface of the resin film 46 is in close proximity to or overlaps or abuts against an outer peripheral edge surface of the electrolyte membrane 40. As shown in FIG. 3, at one end edge portion of the resin film 46 in the direction of the arrow B, the oxygen-containing gas supply passage 34a, the coolant supply passage 36a, and the fuel gas discharge passage 38b are provided. At another end edge portion of the resin film 46 in the direction of the arrow B, the fuel gas supply passage 38a, the coolant discharge passage 36b, and the oxygen-containing gas discharge passage 34b are provided.

For example, the resin film 46 is made of PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether) resin, PET (polyethylene terephthalate), PBT (polybutylene terephthalate), or modified polyolefin. The electrolyte membrane 40 may be formed to project outwardly without using the resin film 46. Further, a frame-shaped film may be disposed on both sides of the outwardly projecting electrolyte membrane 40.

As shown in FIGS. 2 to 5, the first separator 30 and the second separator 32 are joined to each other to thereby constitute a separator member (fuel cell separator member) 10. Stated otherwise, the separator member 10 is a bonded separator equipped with a bonded section 47 in which the outer peripheral portion of the first separator 30 and the outer peripheral portion of the second separator 32 are bonded to each other. The bonding method for joining the first separator 30 and the second separator 32 may be laser welding, seam welding, brazing, caulking, crimping or the like.

The first separator 30 and the second separator 32 are made of metal, for example, such as steel plates, stainless steel plates, aluminum plates, plated steel sheets, or metal plates having anti-corrosive surfaces produced by performing a surface treatment. The first separator 30 and the second separator 32 are formed by corrugating metal thin plates by press forming to each have a corrugated shape in the cross section.

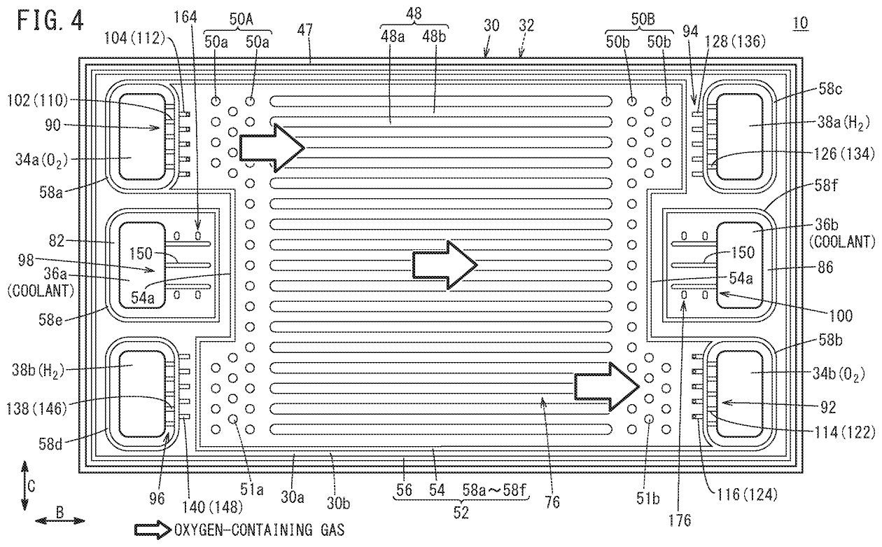

As shown in FIGS. 2 to 4, an oxygen-containing gas flow field 48 extending in the direction of the arrow B, for example, is disposed on a plane or face 30a (referred to hereinafter as a “surface 30a”) of the first separator 30 facing toward the MEA 28. As shown in FIG. 4, the oxygen-containing gas flow field 48 communicates fluidically with the oxygen-containing gas supply passage 34a and the oxygen-containing gas discharge passage 34b. The oxygen-containing gas flow field 48 includes straight flow grooves 48b disposed between a plurality of projections 48a that extend in the direction of the arrow B. Instead of such a plurality of straight flow grooves 48b, a plurality of wavy flow grooves may be provided.

On the surface 30a of the first separator 30, an inlet buffer 50A having a plurality of embossed rows of a plurality of embossed portions 50a aligned in the direction of the arrow C, is disposed between the oxygen-containing gas supply passage 34a and the oxygen-containing gas flow field 48. Further, on the surface 30a of the first separator 30, an outlet buffer 50B having a plurality of embossed rows of a plurality of embossed portions 50b, is disposed between the oxygen-containing gas discharge passage 34b and the oxygen-containing gas flow field 48.

Moreover, on a surface 30b of the first separator 30 on an opposite side from the oxygen-containing gas flow field 48, embossed rows of a plurality of embossed portions 51a aligned in the direction of the arrow C and projecting toward the opposite side are provided between the above-described embossed rows of the inlet buffer 50A, and together therewith, embossed rows of a plurality of embossed portions 51b aligned in the direction of the arrow C and projecting toward the opposite side are provided between the above-described embossed rows of the outlet buffer 50B. The embossed portions 51b constitute buffer sections on the side of the coolant surface.

First seal lines (metal bead seals) 52, which are formed by press forming, are formed to project or bulge out toward the MEA 28 (in an opposite direction to the adjacent second separator 32) on the surface 30a of the first separator 30. The first seal lines 52 prevent the leakage of fluids (the oxygen-containing gas, the fuel gas, and the coolant) to the exterior from between the first separator 30 and the MEA 28. The respective sides of the first seal lines 52 are formed in straight line shapes as viewed in plan (hereinafter, referred to simply as in plan view) from the separator thickness direction (the direction of the arrow A). Moreover, the respective sides of the first seal lines 52 may be formed with wavy shapes as viewed in plan.

As shown in FIG. 2, on projecting end surfaces of the first seal lines 52, first resin members 60 are fixed and attached thereto by printing or coating, etc. For example, polyester fiber is used for the first resin members 60. The first resin members 60 may be provided on the side of the resin film 46. The first resin members 60 are non-essential, and need not necessarily be provided. The first resin members 60 contact the resin film 46 in an airtight and fluidtight manner in a load applied state in which a compressive load is applied to the stacked body 14.

As shown in FIG. 4, the first seal lines 52 include a first inner side bead section 54, a first outer side bead section 56, and a plurality of first communication passage bead sections 58a to 58f.

The first inner side bead section 54 surrounds the oxygen-containing gas flow field 48, the inlet buffer 50A, and the outlet buffer 50B. The first outer side bead section 56 goes around the outer peripheral edge of the surface 30a of the first separator 30 along the inner side of the bonded section 47.

The first communication passage bead section 58a surrounds the oxygen-containing gas supply passage 34a. The first communication passage bead section 58b surrounds the oxygen-containing gas discharge passage 34b. The first communication passage bead section 58c surrounds the fuel gas supply passage 38a. The first communication passage bead section 58d surrounds the fuel gas discharge passage 38b. The first communication passage bead section (first bead seal) 58e surrounds the coolant supply passage 36a. The first communication passage bead section (first bead seal) 58f surrounds the coolant discharge passage 36b.

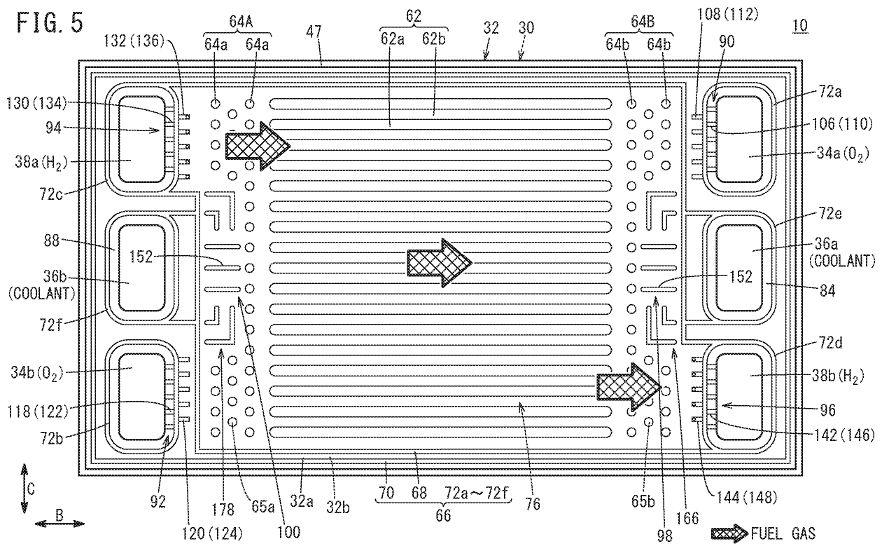

As shown in FIG. 5, a fuel gas flow field 62 extending in the direction of the arrow B, for example, is formed on a plane or face 32a (referred to hereinafter as a “surface 32a”) of the second separator 32 facing toward the MEA 28. The fuel gas flow field 62 communicates fluidically with the fuel gas supply passage 38a and the fuel gas discharge passage 38b. The fuel gas flow field 62 includes straight flow grooves 62b disposed between a plurality of projections 62a that extend in the direction of the arrow B. Instead of such a plurality of straight flow grooves 62b, a plurality of wavy flow grooves may be provided.

On the surface 32a of the second separator 32, an inlet buffer 64A having a plurality of embossed rows of a plurality of embossed portions 64a aligned in the direction of the arrow C is disposed between the fuel gas supply passage 38a and the fuel gas flow field 62. Further, on the surface 32a of the second separator 32, an outlet buffer 64B having a plurality of embossed rows of a plurality of embossed portions 64b is disposed between the fuel gas discharge passage 38b and the fuel gas flow field 62.

Moreover, on a surface 32b of the second separator 32 on an opposite side from the fuel gas flow field 62, embossed rows of a plurality of embossed portions 65a aligned in the direction of the arrow C and projecting toward the opposite side are provided between the above-described embossed rows of the inlet buffer 64A, and together therewith, embossed rows of a plurality of embossed portions 65b aligned in the direction of the arrow C and projecting toward the opposite side are provided between the above-described embossed rows of the outlet buffer 64B. The embossed portions 65b constitute buffer sections on the side of the coolant surface.

Second seal lines 66, which are formed by press forming, are formed to project or bulge out toward the MEA 28 (in an opposite direction to the adjacent first separator 30) on the surface 32a of the second separator 32. The respective sides of the second seal lines 66 are formed in straight line shapes as viewed in plan. Moreover, the respective sides of the second seal lines 66 may be formed with wavy shapes as viewed in plan.

As shown in FIG. 2, on projecting end surfaces of the second seal lines 66, second resin members 74 are fixed and attached thereto by printing or coating, etc. For example, polyester fiber is used for the second resin members 74. The second resin members 74 may be provided on the side of the resin film 46. The second resin members 74 are non-essential, and need not necessarily be provided.

As shown in FIG. 5, the second seal lines 66 include a second inner side bead section 68, a second outer side bead section 70, and a plurality of second communication passage bead sections 72a to 72f.

The second inner side bead section 68 surrounds the fuel gas flow field 62, the inlet buffer 64A, and the outlet buffer 64B. The second outer side bead section 70 goes around the outer peripheral edge of the surface 32a of the second separator 32 along the inner side of the bonded section 47.

The second communication passage bead section 72a surrounds the oxygen-containing gas supply passage 34a. The second communication passage bead section 72b surrounds the oxygen-containing gas discharge passage 34b. The second communication passage bead section 72c surrounds the fuel gas supply passage 38a. The second communication passage bead section 72d surrounds the fuel gas discharge passage 38b. The second communication passage bead section (second bead seal) 72e surrounds the coolant supply passage 36a. The second communication passage bead section (second bead seal) 72f surrounds the coolant discharge passage 36b.

The second communication passage bead section 72a is constructed in the same manner as the first communication passage bead section 58a, and the second communication passage bead section 72b is constructed in the same manner as the first communication passage bead section 58b. The second communication passage bead section 72c is constructed in the same manner as the first communication passage bead section 58c, and the second communication passage bead section 72d is constructed in the same manner as the first communication passage bead section 58d.

As shown in FIGS. 2 and 3, in the separator member 10, a coolant flow field 76 is formed between the first separator 30 and the second separator 32 which are made of metal and are stacked on each other. The coolant flow field 76 is in fluid communication respectively with the coolant supply passage 36a and the coolant discharge passage 36b, which serve as coolant passages that penetrate in the separator thickness direction (the direction of the arrow A). The coolant flow field 76 is formed by stacking and matching together the rear surface shape of the first separator 30 on which the oxygen-containing gas flow field 48 is formed, and the rear surface shape of the second separator 32 on which the fuel gas flow field 62 is formed.

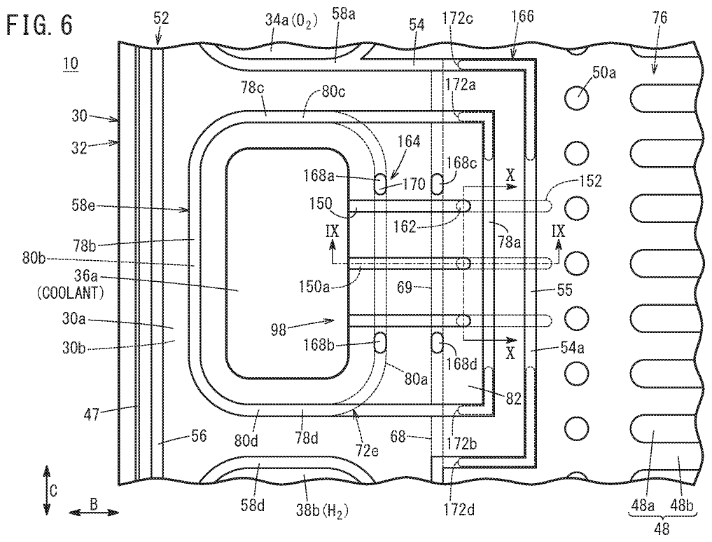

As shown in FIG. 6, the first communication passage bead section 58e that surrounds the coolant supply passage 36a is formed with a rectangular shape as viewed in plan, and a first inner side seal member 78a and a first outer side seal member 78b include two first connecting seal members 78c and 78d.

The first inner side seal member 78a constitutes an end of the first communication passage bead section 58e on the side of the coolant flow field 76, and extends in the direction of the arrow C. The first outer side seal member 78b constitutes an end of the first communication passage bead section 58e on an opposite side from the coolant flow field 76, and extends in the direction of the arrow C. The first inner side seal member 78a and the first outer side seal member 78b extend mutually in parallel with each other.

The first connecting seal member 78c extends in the direction of the arrow B, mutually connecting one end of the first inner side seal member 78a and one end of the first outer side seal member 78b to each other. A connecting portion (intersecting part) of the first connecting seal member 78c and the first inner side seal member 78a, and a connecting portion (intersecting part) of the first connecting seal member 78c and the first outer side seal member 78b, respectively, are preferably formed with rounded shapes as viewed in plan. The first connecting seal member 78d extends in the direction of the arrow B, mutually connecting another end of the first inner side seal member 78a and another end of the first outer side seal member 78b to each other. A connecting portion (intersecting part) of the first connecting seal member 78d and the first inner side seal member 78a, and a connecting portion (intersecting part) of the first connecting seal member 78d and the first outer side seal member 78b, respectively, are preferably formed with rounded shapes as viewed in plan.

As shown in FIG. 4, the first communication passage bead section 58f that surrounds the coolant discharge passage 36b is configured in the same manner as the first communication passage bead section 58e. Therefore, a detailed description of the configuration of the first communication passage bead section 58f is omitted. On portions of the first inner side bead section 54 facing toward the first communication passage bead sections 58e and 58f, protruding portions 54a are provided, which protrude toward the side of the coolant flow field 76 in accordance with the shapes of the first communication passage bead sections 58e and 58f. The protruding portions 54a include first inner side portions 55 located on inner sides of the first communication passage bead sections 58e and 58f.

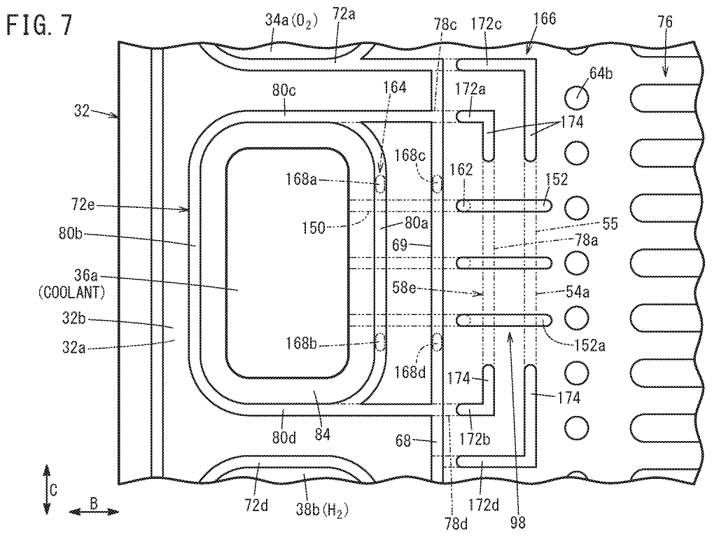

As shown in FIG. 7, the second communication passage bead section 72e that surrounds the coolant supply passage 36a of the second separator 32 is formed with a rectangular shape as viewed in plan, and a second inner side seal member 80a and a second outer side seal member 80b include two second connecting seal members 80c and 80d.

The second connecting seal member 80c extends in the direction of the arrow B, mutually connecting one end of the second inner side seal member 80a and one end of the second outer side seal member 80b to each other. A connecting portion of the second connecting seal member 80c and the second inner side seal member 80a, and a connecting portion of the second connecting seal member 80c and the second outer side seal member 80b, respectively, are preferably formed with rounded shapes as viewed in plan. The second connecting seal member 80d extends in the direction of the arrow B, mutually connecting another end of the second inner side seal member 80a and another end of the second outer side seal member 80b to each other. A connecting portion of the second connecting seal member 80d and the second inner side seal member 80a, and a connecting portion of the second connecting seal member 80d and the second outer side seal member 80b, respectively, are preferably formed with rounded shapes as viewed in plan.

As shown in FIGS. 6 and 7, the second communication passage bead section 72e is formed to have a smaller dimension in the direction of the arrow B than the first communication passage bead section 58e. More specifically, the second inner side seal member 80a is in closer proximity to the coolant supply passage 36a than the first inner side seal member 78a. The second inner side seal member 80a does not overlap with the first inner side seal member 78a when viewed in plan from the separator thickness direction. The second outer side seal member 80b and the second connecting seal members 80c and 80d include overlapping portions that overlap with the first outer side seal member 78b and the first connecting seal members 78c and 78d. Stated otherwise, the entirety of the second outer side seal member 80b overlaps with the first outer side seal member 78b, a portion of the second connecting seal member 80c overlaps with the first connecting seal member 78c, and a portion of the second connecting seal member 80d overlaps with the first connecting seal member 78d.

As shown in FIG. 5, the second communication passage bead section 72f that surrounds the coolant discharge passage 36b is configured in the same manner as the second communication passage bead section 72e. Therefore, a detailed description of the configuration of the second communication passage bead section 72f is omitted. As shown in FIG. 6 and FIG. 7, the first inner side portion 55 is positioned more on the side of the coolant flow field 76 than a second inner side portion 69, which within the second inner side bead section 68, is positioned more on an inner side than the second communication passage bead sections 72e and 72f.

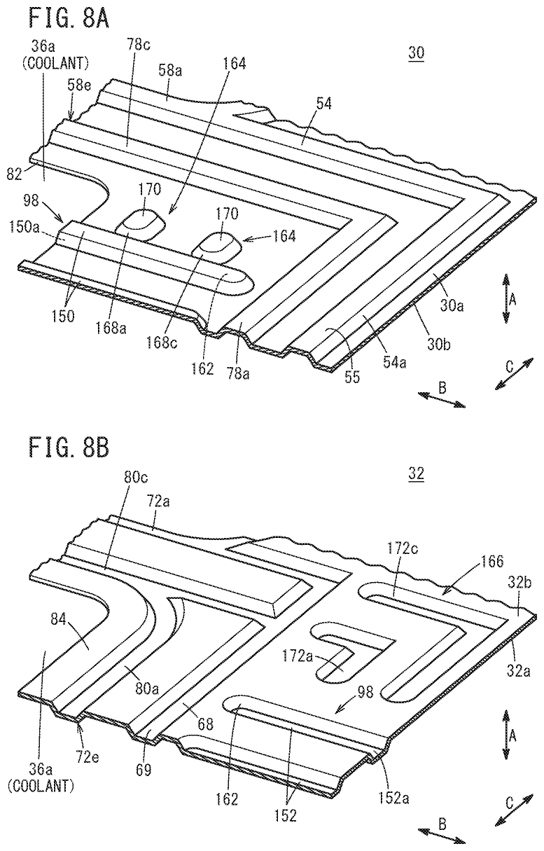

As shown in FIGS. 4 and 8A, a first flat portion 82 extending in a planar shape is disposed between the coolant supply passage 36a and the first communication passage bead section 58e in the first separator 30. It should be noted that, in FIG. 8A, illustration of the first resin members 60 is omitted. As shown in FIGS. 5 and 8B, a second flat portion 84 extending in a planar shape is disposed between the coolant supply passage 36a and the second communication passage bead section 72e in the second separator 32. It should be noted that, in FIG. 8B, illustration of the second resin members 74 is omitted. The first flat portion 82 and the second flat portion 84 are in contact with each other.

As shown in FIG. 4, a first flat portion 86 extending in a planar shape is disposed between the coolant discharge passage 36b and the first communication passage bead section 58f in the first separator 30. As shown in FIG. 5, a second flat portion 88 extending in a planar shape is disposed between the coolant discharge passage 36b and the second communication passage bead section 72f in the second separator 32. The first flat portion 86 and the second flat portion 88 are in contact with each other.

As shown in FIGS. 4 and 5, an oxygen-containing gas inlet bridge section 90, an oxygen-containing gas outlet bridge section 92, a fuel gas inlet bridge section 94, a fuel gas outlet bridge section 96, a coolant inlet bridge section 98, and a coolant outlet bridge section 100 are provided in the separator member 10.

As shown in FIG. 4, the oxygen-containing gas inlet bridge section 90 enables mutual communication between the oxygen-containing gas supply passage 34a and the oxygen-containing gas flow field 48. The oxygen-containing gas inlet bridge section 90 includes a plurality of first inner side tunnels 102 (see FIG. 4) and a plurality of first outer side tunnels 104 (see FIG. 4) that are formed in the first separator 30, and a plurality of second inner side tunnels 106 (see FIG. 5) and a plurality of second outer side tunnels 108 (see FIG. 5) that are formed in the second separator 32.

In FIG. 4, the first inner side tunnels 102 and the first outer side tunnels 104 protrude respectively from the surface 30a of the first separator 30 in a direction opposite to the adjacent second separator 32. The first inner side tunnels 102 extend from an inner peripheral wall of the first communication passage bead section 58a toward the oxygen-containing gas supply passage 34a. The first outer side tunnels 104 extend from an outer peripheral wall of the first communication passage bead section 58a toward the oxygen-containing gas flow field 48. Openings are provided at extending ends of the first outer side tunnels 104, whereby the oxygen-containing gas supply passage 34a and the oxygen-containing gas flow field 48 communicate fluidically.

In FIG. 5, the second inner side tunnels 106 and the second outer side tunnels 108 protrude respectively from the surface 32a of the second separator 32 in a direction opposite to the adjacent first separator 30. The second inner side tunnels 106 extend from an inner peripheral wall of the second communication passage bead section 72a toward the oxygen-containing gas supply passage 34a. The second outer side tunnels 108 extend from an outer peripheral wall of the second communication passage bead section 72a toward the oxygen-containing gas flow field 48.

As shown in FIGS. 4 and 5, the first inner side tunnels 102 and the second inner side tunnels 106 overlap with each other as viewed in plan, in a manner so that individual inner side passages 110 are formed in communication with each other. The first outer side tunnels 104 and the second outer side tunnels 108 overlap with each other as viewed in plan, in a manner so that individual outer side passages 112 are formed in communication with each other. The inner side passages 110 and the outer side passages 112 communicate with each other via an internal hole formed between the first communication passage bead section 58a and the second communication passage bead section 72a.

The oxygen-containing gas outlet bridge section 92, the fuel gas inlet bridge section 94, and the fuel gas outlet bridge section 96 are constituted respectively in the same manner as the oxygen-containing gas inlet bridge section 90. Therefore, the oxygen-containing gas outlet bridge section 92, the fuel gas inlet bridge section 94, and the fuel gas outlet bridge section 96 are only briefly described, and descriptions of detailed configurations thereof are omitted.

As shown in FIG. 4, the oxygen-containing gas outlet bridge section 92 enables mutual communication between the oxygen-containing gas flow field 48 and the oxygen-containing gas discharge passage 34b. The oxygen-containing gas outlet bridge section 92 includes a plurality of first inner side tunnels 114 (see FIG. 4) and a plurality of first outer side tunnels 116 (see FIG. 4) that are formed in the first separator 30, and a plurality of second inner side tunnels 118 (see FIG. 5) and a plurality of second outer side tunnels 120 (see FIG. 5) that are formed in the second separator 32.

As shown in FIGS. 4 and 5, the first inner side tunnels 114 and the second inner side tunnels 118 communicate with each other to thereby form inner side passages 122. The first outer side tunnels 116 and the second outer side tunnels 120 communicate with each other to thereby form outer side passages 124. The inner side passages 122 and the outer side passages 124 communicate with each other via an internal hole formed between the first communication passage bead section 58b and the second communication passage bead section 72b.

As shown in FIG. 5, the fuel gas inlet bridge section 94 enables mutual communication between the fuel gas supply passage 38a and the fuel gas flow field 62. The fuel gas inlet bridge section 94 includes a plurality of first inner side tunnels 126 (see FIG. 4) and a plurality of first outer side tunnels 128 (see FIG. 4) that are formed in the first separator 30, and a plurality of second inner side tunnels 130 (see FIG. 5) and a plurality of second outer side tunnels 132 (see FIG. 5) that are formed in the second separator 32.

As shown in FIGS. 4 and 5, the first inner side tunnels 126 and the second inner side tunnels 130 communicate with each other to thereby form inner side passages 134. The first outer side tunnels 128 and the second outer side tunnels 132 communicate with each other to thereby form outer side passages 136. The inner side passages 134 and the outer side passages 136 communicate with each other via an internal hole formed between the first communication passage bead section 58c and the second communication passage bead section 72c.

As shown in FIG. 5, the fuel gas outlet bridge section 96 enables mutual communication between the fuel gas flow field 62 and the fuel gas discharge passage 38b. The fuel gas outlet bridge section 96 includes a plurality of first inner side tunnels 138 (see FIG. 4) and a plurality of first outer side tunnels 140 (see FIG. 4) that are formed in the first separator 30, and a plurality of second inner side tunnels 142 (see FIG. 5) and a plurality of second outer side tunnels 144 (see FIG. 5) that are formed in the second separator 32.

As shown in FIGS. 4 and 5, the first inner side tunnels 138 and the second inner side tunnels 142 communicate with each other to thereby form inner side passages 146. The first outer side tunnels 140 and the second outer side tunnels 144 communicate with each other to thereby form outer side passages 148. The inner side passages 146 and the outer side passages 148 communicate with each other via an internal hole formed between the first communication passage bead section 58d and the second communication passage bead section 72d.

As shown in FIGS. 6 to 9, the coolant inlet bridge section 98 enables mutual communication between the coolant supply passage 36a and the coolant flow field 76. The coolant inlet bridge section 98 includes a plurality of first projections 150 that are formed in the first separator 30, and a plurality of second projections 152 that are formed in the second separator 32.

The number of first projections 150 and the number of second projections 152 are the same as each other. According to the present embodiment, an example is illustrated in which three first projections 150 and three second projections 152 are provided. However, the respective numbers of the first projections 150 and the second projections 152 may be one, two, or four or more.

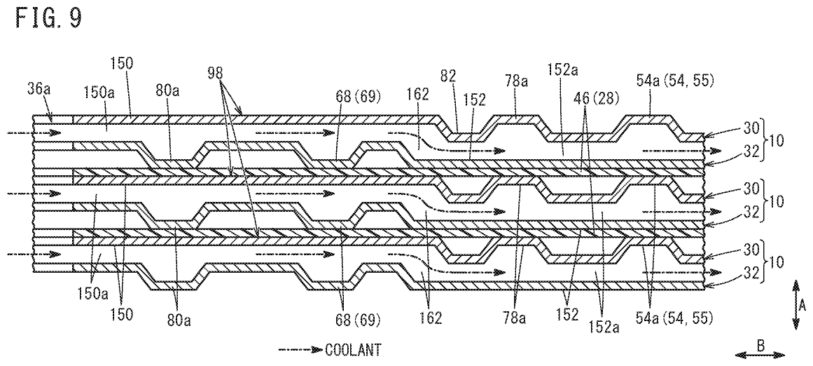

As shown in FIG. 6, FIG. 8A, and FIG. 9, the plurality of first projections 150 are formed in the first flat portion 82 in a manner so as to be separated from the first communication passage bead section 58e. The plurality of first projections 150 are juxtaposed in a state of being separated mutually from one another in the direction of the arrow C (see FIGS. 6 and 8A). The respective first projections 150 project from the surface 30a of the first separator 30 (the surface of the first flat portion 82) in a direction opposite to the adjacent second separator 32, and have first communication passages 150a formed therein that communicate with the coolant supply passage 36a.

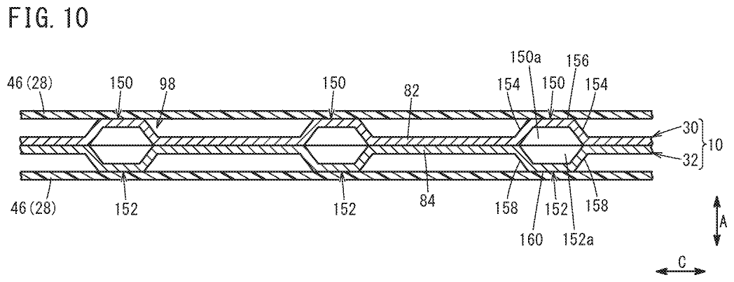

As shown in FIG. 10, the cross-sectional shape of each of the first projections 150 is a trapezoidal shape which is tapered toward the tip end side thereof. Side walls 154 on both sides of the respective first projections 150 are inclined with respect to the separator thickness direction (the direction of the arrow A). In the load applied state in which the MEAs 28 and the separator members 10 are alternately stacked and a compressive load is applied in the stacking direction, the projecting end surfaces 156 of the first projections 150 are in surface contact with the MEAs 28 (resin films 46) that lie adjacent to the first separators 30. More specifically, the projecting heights of each of the first projections 150 are set so as to receive the compressive load in the load applied state in which the compressive load is applied to the stacked body 14.

According to the present embodiment, the projecting end surfaces 156 of the first projections 150 are flat surfaces. However, as long as they are capable of being placed in surface contact with the MEAs 28 in the load applied state, the projecting end surfaces 156 of the first projections 150 may be of shapes other than flat surfaces, such as convexly shaped curved surfaces, for example.

As shown in FIG. 6, FIG. 8A, and FIG. 9, each of the first projections 150 extends from an opening edge of the coolant supply passage 36a toward the coolant flow field 76 in the direction of the arrow B. As shown in FIG. 6, the respective first projections 150 extend in a manner so as to intersect with the second inner side seal member 80a and the second inner side bead section 68 as viewed in plan. Consequently, each of the first projections 150 is capable of receiving the reaction force of the surface pressure of the second communication passage bead sections 72e (second inner side seal member 80a) and the second inner side bead sections 68 of the second separators 32 of the separator members 10 that are disposed adjacent to and sandwich the MEAs 28 (resin films 46) therebetween (see FIG. 9).

Specifically, extending end parts of the respective first projections 150 are positioned between the first inner side seal member 78a and the second inner side seal member 80a as viewed in plan from the separator thickness direction. Stated otherwise, as viewed in plan from the separator thickness direction, the extending end parts (end parts on the side of the coolant flow field 76) of the first projections 150 are positioned more on the side of the coolant flow field 76 than the second inner side bead section 68. More specifically, the extending end parts of the first projections 150 are slightly shifted toward the side of the coolant supply passage 36a more so than the first inner side seal member 78a.

As shown in FIG. 7, FIG. 8B, and FIG. 9, the plurality of second projections 152 are formed between the second communication passage bead section 72e and the coolant flow field 76, in a manner so as to be separated with respect to the second communication passage bead section 72e. The plurality of second projections 152 are juxtaposed in a state of being separated mutually from one another in the direction of the arrow C (see FIGS. 7 and 8B). The respective second projections 152 project from the surface 32a of the second separator 32 in a direction opposite to the adjacent first separator 30, and have second communication passages 152a formed therein that enable mutual communication between the first communication passages 150a and the coolant flow field 76.

As shown in FIG. 10, the cross-sectional shape of each of the second projections 152 is a trapezoidal shape which is tapered toward the tip end side thereof. Side walls 158 on both sides of the respective second projections 152 are inclined with respect to the separator thickness direction (the direction of the arrow A). In the load applied state in which a compressive load is applied in the stacking direction to the stacked body 14, projecting end surfaces 160 of the respective second projections 152 are in surface contact with the MEAs 28 (resin films 46) that lie adjacent to the second separators 32. More specifically, the projecting heights of each of the second projections 152 are set so as to receive the compressive load in the load applied state in which the compressive load is applied to the stacked body 14.

According to the present embodiment, the projecting end surfaces 160 of the second projections 152 are flat surfaces. However, as long as they are capable of being placed in surface contact with the MEAs 28 in the load applied state, the projecting end surfaces 160 of the second projections 152 may be of shapes other than flat surfaces, such as convexly shaped curved surfaces, for example.

As shown in FIG. 7, the respective second projections 152 extend in the direction of the arrow B, in a manner so as to intersect with the protruding portions 54a of the first inner side seal member 78a and the first inner side bead section 54 as viewed in plan. Consequently, each of the second projections 152 is capable of receiving the reaction force of the surface pressure of the first communication passage bead sections 58e (first inner side seal members 78a) and the first inner side bead sections 54 of the first separators 30 of the separator members 10 that are disposed adjacent to and sandwich the MEAs 28 (resin films 46) therebetween (see FIG. 9).

End parts (end parts on the side of the coolant supply passage 36a) of the second protrusions 152 overlap with the extending end parts of the first projections 150 as viewed in plan. Stated otherwise, connecting parts 162 connecting the first communication passages 150a and the second communication passages 152a are positioned between the first inner side seal member 78a and the second inner side seal member 80a as viewed in plan. The connecting parts 162 are located between the first inner side portion 55 and the second inner side portion 69. Stated otherwise, the connecting parts 162 are positioned between the second inner side portion 69 and the first inner side seal member 78a. As viewed in plan from the separator thickness direction, other end parts (end parts on the side of the coolant flow field 76) of the second projections 152 are positioned more on the side of the coolant flow field 76 than the protruding portions 54a of the first inner side bead section 54.

As shown in FIGS. 6 to 8B, a first pressure receiving member 164 which is provided on the first separator 30, and a second pressure receiving member 166 which is provided on the second separator 32 are disposed in the vicinity of the coolant supply passage 36a within the separator member 10. As shown in FIGS. 6 and 8A, the first pressure receiving member 164 includes a plurality of first protrusions 168a to 168d that protrude from the surface 30a (the surface of the first flat portion 82) of the first separator 30 in a direction opposite to the adjacent second separator 32. In the load applied state, projecting end surfaces 170 of the respective first protrusions 168a to 168d are in surface contact with the MEAs 28 (resin films 46) that lie adjacent to the second separators 32.

According to the present embodiment, the projecting end surfaces 170 of each of the first protrusions 168a to 168d are elliptically shaped flat surfaces. However, as long as they are capable of being placed in surface contact with the MEAs 28 in the load applied state, the projecting end surfaces 170 of the respective first protrusions 168a to 168d may be of shapes other than flat surfaces, such as convexly shaped curved surfaces, for example. Further, the planar shape of the projecting end surfaces 170 of the respective first protrusions 168a to 168d is not limited to being an elliptical shape, and may be of a perfect circular shape or a polygonal shape.

As shown in FIG. 6, the first protrusion 168a and the first protrusion 168b overlap with the second inner side seal member 80a, and sandwich the plurality of first projections 150 from directions of the arrow C as viewed in plan from the separator thickness direction. Consequently, the first protrusions 168a and 168b are capable of receiving the reaction force of the surface pressure of the second communication passage bead sections 72e (second inner side seal members 80a) of the second separators 32 of the separator members 10 that are disposed adjacent to and sandwich the MEAs 28 (resin films 46) therebetween. The first protrusion 168a is positioned between the first connecting seal member 78c and the first projection 150. The first protrusion 168b is positioned between the first connecting seal member 78d and the first projection 150.

The first protrusion 168c and the first protrusion 168d overlap with the second inner side bead section 68 (the second inner side portion 69) as viewed in plan from the separator thickness direction, and sandwich the plurality of first projections 150 from the directions of the arrow C. Consequently, the first protrusions 168c and 168d are capable of receiving the reaction force of the surface pressure of the second inner side bead sections 68 of the second separators 32 of the separator members 10 that are disposed adjacent to and sandwich the MEAs 28 (resin films 46) therebetween. The first protrusion 168c is positioned between the first connecting seal member 78c and the first projection 150. The first protrusion 168d is positioned between the first connecting seal member 78d and the first projection 150.

As shown in FIGS. 7 and 8B, the second pressure receiving member 166 includes a plurality of second protrusions 172a to 172d that protrude from the surface 32a of the second separator 32 in a direction opposite to the adjacent first separator 30. In the load applied state, projecting end surfaces 174 of the respective second protrusions 172a to 172d are in surface contact with the MEAs 28 (resin films 46) that lie adjacent to the first separators 30.

As shown in FIG. 7, according to the present embodiment, the projecting end surfaces 174 of each of the second protrusions 172a to 172d are substantially L-shaped flat surfaces. However, as long as they are capable of being placed in surface contact with the anodes 42 of the MEAs 28 in the load applied state, the projecting end surfaces 174 of the respective second protrusions 172a to 172d may be of shapes other than flat surfaces, such as convexly shaped curved surfaces, for example. Further, the planar shape of the projecting end surfaces 174 of the respective second protrusions 172a to 172d is not limited to being substantially L-shaped, and may be of a perfect circular shape, an elliptical shape, a quadrilateral shape, or the like.

As shown in FIG. 7, the second protrusion 172a and the second protrusion 172b overlap with the first inner side seal member 78a and the first connecting seal members 78c and 78d, and sandwich the plurality of second projections 152 from directions of the arrow C as viewed in plan from the separator thickness direction. Consequently, the second protrusions 172a and 172b are capable of receiving the reaction force of the surface pressure of the first communication passage bead sections 58e of the first separators 30 of the separator members 10 that are disposed adjacent to and sandwich the MEAs 28 (resin films 46) therebetween (see FIG. 6). The second protrusion 172a is positioned at a connecting portion (intersecting part) of the first inner side seal member 78a and the first connecting seal member 78c. The second protrusion 172b is positioned at a connecting portion (intersecting part) of the first inner side seal member 78a and the first connecting seal member 78d.

The second protrusion 172c and the second protrusion 172d overlap with angled parts of the protruding portions 54a of the first inner side bead section 54 as viewed in plan from the separator thickness direction, and sandwich the plurality of second projections 152 from the directions of the arrow C. Stated otherwise, the second protrusion 172c and the second protrusion 172d are positioned so as to overlap with the first inner side portion 55 as viewed in plan from the separator thickness direction. Consequently, the second protrusions 172c and 172d are capable of receiving the reaction force of the surface pressure of the first inner side bead sections 54 of the first separators 30 of the separator members 10 that are disposed adjacent to and sandwich the MEAs 28 (resin films 46) therebetween (see FIG. 6).

As shown in FIGS. 4 to 5, a first pressure receiving member 176 which is provided on the first separator 30, and a second pressure receiving member 178 which is provided on the second separator 32 are disposed in the vicinity of the coolant discharge passage 36b within the separator member 10. The first pressure receiving member 176 is configured in the same manner as the above-described first pressure receiving member 164, and the second pressure receiving member 178 is configured in the same manner as the above-described second pressure receiving member 166. Therefore, detailed descriptions of the first pressure receiving member 176 and the second pressure receiving member 178 are omitted.

Operations of the fuel cell stack 11, which is configured in the foregoing manner, will now be described.

First, as shown in FIG. 1, an oxygen-containing gas, for example air, is supplied from the oxygen-containing gas supply passage 34a of the end plate 20a. A fuel gas such as a hydrogen-containing gas or the like is supplied to the fuel gas supply passage 38a of the end plate 20a. Further, a coolant such as pure water, ethylene glycol, or oil is supplied to the coolant supply passage 36a of the end plate 20a.

As shown in FIG. 4, the oxygen-containing gas is introduced from the oxygen-containing gas supply passage 34a and via the oxygen-containing gas inlet bridge section 90 into the oxygen-containing gas flow field 48 of the first separator 30. In addition, the oxygen-containing gas moves along the oxygen-containing gas flow field 48 in the direction of the arrow B, and the oxygen-containing gas is supplied to the cathode 44 of the MEA main body 28a.

On the other hand, as shown in FIG. 5, the fuel gas is introduced from the fuel gas supply passage 38a and via the fuel gas inlet bridge section 94 into the fuel gas flow field 62 of the second separator 32. In addition, the fuel gas moves in the direction of the arrow B along the fuel gas flow field 62, and is supplied to the anode 42 of the MEA main body 28a.

Accordingly, in each of the MEA main bodies 28a, the oxygen-containing gas supplied to the cathode 44 and the fuel gas supplied to the anode 42 are partially consumed in electrochemical reactions, and thereby generate electricity.

Next, as shown in FIG. 4, the oxygen-containing gas, which is supplied to and partially consumed at the cathode 44, flows from the oxygen-containing gas flow field 48, through the oxygen-containing gas outlet bridge section 92, and to the oxygen-containing gas discharge passage 34b, and the oxygen-containing gas is discharged in the direction of the arrow A toward the oxygen-containing gas discharge passage 34b. In the same way, as shown in FIG. 5, the fuel gas, which is supplied to and partially consumed at the anode 42, flows from the fuel gas flow field 62, through the fuel gas outlet bridge section 96, and to the fuel gas discharge passage 38b, and the fuel gas is discharged in the direction of the arrow A toward the fuel gas discharge passage 38b.

Further, as shown in FIG. 3, the coolant that is supplied to the coolant supply passage 36a is introduced to the coolant flow field 76, which is formed between the first separator 30 and the second separator 32, from the coolant supply passage 36a via the coolant inlet bridge section 98. At this time, as shown in FIG. 9, the coolant, after having flowed through the first communication passages 150a of the first projections 150 that are formed in the first separator 30, flows via the connecting parts 162 through the second communication passages 152a of the second projections 152 that are formed in the second separator 32, and is led into the coolant flow field 76. In addition, the coolant, by flowing through the coolant flow field 76 in the direction of the arrow B, cools the membrane electrode assembly 28.

Next, the coolant having flowed through the coolant flow field 76 flows from the coolant flow field 76 and through the coolant outlet bridge section 100 to the coolant discharge passage 36b, whereupon the coolant is discharged in the direction of the arrow A along the coolant discharge passage 36b.

In this case, the separator member 10 and the fuel cell stack 11 according to the present embodiment exhibit the following advantageous effects.

According to the present embodiment, since the first projections 150 are not connected to the first bead seals (the first communication passage bead sections 58e and 58f), notched portions are not formed in the first bead seals (the first communication passage bead sections 58e and 58f). Further, since the second projections 152 are not connected to the second bead seals (the second communication passage bead sections 72e and 72f), notched portions are not formed in the second bead seals (the second communication passage bead sections 72e and 72f). Therefore, the load bearing characteristics of the first bead seals (the first communication passage bead sections 58e and 58f) and the second bead seals (the second communication passage bead sections 72e and 72f) do not undergo deterioration. Thus, with a simple and economical configuration, the surface pressure applied to the first bead seals (the first communication passage bead sections 58e and 58f) and the second bead seals (the second communication passage bead sections 72e and 72f) that surround the coolant passages (the coolant supply passage 36a and the coolant discharge passage 36b) can be made uniform.

The first projections 150 and the second projections 152 are set respectively to projecting heights so as to receive the compressive load, in a load applied state in which the compressive load is applied.

In accordance with such a configuration, the reaction force of the surface pressure of the first bead seals (the first communication passage bead sections 58e and 58f) can be received by the second projections 152, and the reaction force of the surface pressure of the second bead seals (the second communication passage bead sections 72e and 72f) can be received by the first projections 150.

A plurality of the first projections 150 are provided in a mutually separated state, and a plurality of the second projections 152 are provided in a mutually separated state.

In accordance with such a configuration, the reaction force of the surface pressure of the first bead seals (the first communication passage bead sections 58e and 58f) can be received effectively by the plurality of second projections 152, and the reaction force of the surface pressure of the second bead seals (the second communication passage bead sections 72e and 72f) can be received effectively by the plurality of first projections 150.

The first inner side seal members 78a, which constitute end portions of the first bead seals (the first communication passage bead sections 58e and 58f) on the side of the coolant flow field 76, are positioned more on the side of the coolant flow field 76 than the second inner side seal members 80a, which constitute end portions of the second bead seals (the second communication passage bead sections 72e and 72f) on the side of the coolant flow field 76. When viewed in plan from the separator thickness direction, the first projections 150 intersect with the second inner side seal members 80a, and the second projections 152 intersect with the first inner side seal members 78a. The connecting parts 162 connecting the first communication passages 150a and the second communication passages 152a are positioned between the first inner side seal members 78a and the second inner side seal members 80a.

In accordance with such a configuration, the configuration of the separator member 10 can be simplified.

The first flat portions 82 and 86 which extend in planar shapes are disposed between the coolant passages (the coolant supply passage 36a and the coolant discharge passage 36b) and the first bead seals (the first communication passage bead sections 58e and 58f) within the first separator 30. The second flat portions 84 and 88 which extend in planar shapes are disposed between the coolant passages (the coolant supply passage 36a and the coolant discharge passage 36b) and the second bead seals (the second communication passage bead sections 72e and 72f) within the second separator 32. The first flat portions 82 and 86 and the second flat portions 84 and 88 are in contact with each other.

In accordance with such a configuration, the coolant passages (the coolant supply passage 36a and the coolant discharge passage 36b) can be efficiently guided to the first communication passages 150a.

The separator member 10 is equipped with the first pressure receiving members 164 and 176 which project in a direction opposite to the second separator 32 from the surface 30a of the first separator 30, and the second pressure receiving members 166 and 178 which project in a direction opposite to the first separator 30 from the surface 32a of the second separator 32. When viewed in plan from the separator thickness direction, the first pressure receiving members 164 and 176 are positioned so as to overlap with the second inner side seal member 80a, and the second pressure receiving members 166 and 178 are positioned so as to overlap with the first inner side seal member 78a. The first pressure receiving members 164 and 176 and the second pressure receiving members 166 and 178 are formed respectively so as to receive the compressive load in the load applied state.

In accordance with such a configuration, the reaction force of the surface pressure of the first bead seals (the first communication passage bead sections 58e and 58f) can be received by the second pressure receiving member 166, and the reaction force of the surface pressure of the second bead seals (the second communication passage bead sections 72e and 72f) can be received by the first pressure receiving member 164.

The separator member 10 is equipped with the bonded section 47 in which the outer peripheral portion of the first separator 30 and the outer peripheral portion of the second separator 32 are bonded to each other.

In accordance with such a configuration, the first separator 30 and the second separator 32 can be integrated together in a simple manner.

The fuel cell stack 11 is constituted by alternately stacking the separator members 10 and the membrane electrode assemblies 28.

The fuel cell separator member and the fuel cell stack according to the present invention are not limited to the above-described embodiments, and it goes without saying that various alternative or additional configurations could be adopted therein without departing from the essence and gist of the present invention.

What is claimed is:

1. A fuel cell separator member comprising a first separator and a second separator which are made of metal and stacked on each other, and in which there are formed:
a coolant flow field provided between the first separator and the second separator;
a coolant passage that penetrates in a separator thickness direction; and
a bridge section configured to enable mutual communication between the coolant flow field and the coolant passage;
wherein a first bead seal configured to prevent fluid leakage and which projects in an opposite direction to the second separator from a surface of the first separator in a surrounding manner to the coolant passage, is formed in the first separator;
a second bead seal configured to prevent fluid leakage and which projects in an opposite direction to the first separator from a surface of the second separator in a surrounding manner to the coolant passage, is formed in the second separator; and
the fuel cell separator member is stacked on a membrane electrode assembly and a compressive load is applied thereto in a stacking direction;
wherein the bridge section includes:
a first projection formed in a spaced apart manner with respect to the first bead seal, and which projects in an opposite direction to the second separator from the surface of the first separator, and forms a first communication passage communicating with the coolant passage; and
a second projection formed in a spaced apart manner with respect to the second bead seal, and which projects in an opposite direction to the first separator from the surface of the second separator, and forms a second communication passage configured to enable mutual communication between the first communication passage and the coolant flow field; and
wherein, as viewed in plan from the separator thickness direction, the first projection extends in a manner so as to intersect with the second bead seal, and the second projection extends in a manner so as to intersect with the first bead seal.

2. The fuel cell separator member according to claim 1, wherein the first projection and the second projection are set respectively to a projecting height so as to receive the compressive load, in a load applied state in which the compressive load is applied.

3. The fuel cell separator member according to claim 2, wherein:
a plurality of the first projections are provided in a mutually separated state; and
a plurality of the second projections are provided in a mutually separated state.

4. The fuel cell separator member according to claim 2, wherein:
a first inner side seal member of an end portion of the first bead seal on a side of the coolant flow field is positioned more on the side of the coolant flow field than a second inner side seal member of an end portion of the second bead seal on the side of the coolant flow field;
as viewed in plan from the separator thickness direction, the first projection intersects with the second inner side seal member, and the second projection intersects with the first inner side seal member; and
a connecting part connecting the first communication passage and the second communication passage is positioned between the first inner side seal member and the second inner side seal member.

5. The fuel cell separator member according to claim 1, wherein:
a first flat portion extending in a planar shape is disposed between the coolant passage and the first bead seal in the first separator;
a second flat portion extending in a planar shape is disposed between the coolant passage and the second bead seal in the second separator; and
the first flat portion and the second flat portion are in contact with each other.

6. The fuel cell separator member according to claim 4, further comprising:
a first pressure receiving member which projects in a direction opposite to the second separator from the surface of the first separator; and
a second pressure receiving member which projects in a direction opposite to the first separator from the surface of the second separator;
wherein, when viewed in plan from the separator thickness direction, the first pressure receiving member is positioned so as to overlap with the second inner side seal member, and the second pressure receiving member is positioned so as to overlap with the first inner side seal member: and
the first pressure receiving member and the second pressure receiving member are formed respectively so as to receive the compressive load in the load applied state.

7. The fuel cell separator member according to claim 1, further comprising: a bonded section in which an outer peripheral portion of the first separator and an outer peripheral portion of the second separator are bonded to each other.

8. The fuel cell separator member according to claim 6, wherein:
a first inner side bead section configured to prevent fluid leakage and which projects in a direction opposite to the second separator from the surface of the first separator in a surrounding manner to the coolant flow field, is formed on the first separator;
a second inner side bead section configured to prevent fluid leakage and which projects in a direction opposite to the first separator from the surface of the second separator in a surrounding manner to the coolant flow field, is formed on the second separator; and
a first inner side portion of the first inner side bead section located on an inner side of the first bead seal is positioned more on the side of the coolant flow field than a second inner side portion of the second inner side bead section located on an inner side of the second bead seal.

9. The fuel cell separator member according to claim 8, wherein the connecting part is positioned between the first inner side portion and the second inner side portion.

10. The fuel cell separator member according to claim 8, wherein, as viewed in plan from the separator thickness direction, the first pressure receiving member is positioned so as to overlap with the second inner side portion, and the second pressure receiving member is positioned so as to overlap with the first inner side portion.

11. The fuel cell separator member according to claim 6, wherein:
the first pressure receiving member includes a plurality of first protrusions; and
the second pressure receiving portion includes a plurality of second protrusions.

12. A fuel cell stack comprising separator members and a membrane electrode assembly alternately stacked on each other, the separator members each comprising a first separator and a second separator which are made of metal and stacked on each other:
wherein in each of the fuel cell separator members, there are formed:
a coolant flow field provided between the first separator and the second separator;
a coolant passage that penetrates in a separator thickness direction; and
a bridge section configured to enable mutual communication between the coolant flow field and the coolant passage;
wherein a first bead seal configured to prevent fluid leakage and which projects in an opposite direction to the second separator from a surface of the first separator in a surrounding manner to the coolant passage, is formed in the first separator;
a second bead seal configured to prevent fluid leakage and which projects in an opposite direction to the first separator from a surface of the second separator in a surrounding manner to the coolant passage, is formed in the second separator; and
the fuel cell separator members are stacked on the membrane electrode assembly and a compressive load is applied thereto in a stacking direction;
wherein the bridge section includes:
a first projection formed in a spaced apart manner with respect to the first bead seal, and which projects in an opposite direction to the second separator from the surface of the first separator, and forms a first communication passage communicating with the coolant passage; and
a second projection formed in a spaced apart manner with respect to the second bead seal, and which projects in an opposite direction to the first separator from the surface of the second separator, and forms a second communication passage configured to enable mutual communication between the first communication passage and the coolant flow field; and
wherein, as viewed in plan from the separator thickness direction, the first projection extends in a manner so as to intersect with the second bead seal, and the second projection extends in a manner so as to intersect with the first bead seal.
